(19) United States
(12) Patent Application Publication
(10) Pub. No.: US 2022/0083964 A1
(43) Pub. Date: Mar. 17, 2022

(54) PACKAGE DELIVERY VERIFICATION

(71) Applicant: International Business Machines Corporation, Armonk, NY (US)

(72) Inventors: Zachary A. Silverstein, Jacksonville, FL (US); Lisa Seacat Deluca, Baltimore, MD (US); Jeremy R. Fox, Georgetown, TX (US)

(21) Appl. No.: 17/019,282

(22) Filed: Sep. 13, 2020

(51) Int. Cl. G06Q 10/08; G06Q 30/02; G06K 9/62; G06T 7/70

(52) U.S. Cl. CPC G06Q 10/0833; G06T 7/70; G06K 9/628; G06Q 30/0282

(57) ABSTRACT

In an approach to verifying a package is delivered to a proper location, one or more computer processors receive a first image of a first delivered package from a courier, where the image includes an indication of a first delivery location of the first delivered package. One or more computer processors receive feedback associated with receipt of the first delivered package from a recipient of the first delivered package. Based on the received feedback, one or more computer processors determine the delivery of the first delivered package is successful. In response to determining the delivery of the first delivered package is successful, one or more computer processors extract one or more location identifiers from the first image. Based on the first image, the feedback, and the one or more location identifiers, one or more computer processors generate a location confidence threshold.

### BACKGROUND OF THE INVENTION

The present invention relates generally to the field of delivery of goods and materials, and more particularly to verifying a package is delivered to a proper location.

Delivery services (also known as courier services, mail services, and shipping services), such as those offered by the U.S. Postal Service and commercial carriers, provide delivery of letters, packages, and parcels (hereinafter referred to as “packages”) to and from residences and businesses across the United States. Other delivery services may be provided by merchants, retailers, manufacturers, or other organizations that desire to deliver products to users.

Currently, many industries are trending toward cognitive models enabled by big data platforms and machine learning models. Cognitive models, also referred to as cognitive entities, are designed to remember the past, interact with humans, continuously learn, and continuously refine responses for the future with increasing levels of prediction. Machine learning explores the study and construction of algorithms that can learn from and make predictions based on data. Such algorithms operate by building a model from example inputs in order to make data-driven predictions or decisions expressed as outputs, rather than following strictly static program instructions. Within the field of data analytics, machine learning is a method used to devise complex models and algorithms that lend themselves to prediction. These analytical models allow researchers, data scientists, engineers, and analysts to produce reliable, repeatable decisions and results and to uncover hidden insights through learning from historical relationships and trends in the data.

### SUMMARY

Embodiments of the present invention disclose a method, a computer program product, and a system for verifying a package is delivered to a proper location. The method may include one or more computer processors receiving a first image of a first delivered package from a courier, where the image includes an indication of a first delivery location of the first delivered package. One or more computer processors receive feedback associated with receipt of the first delivered package from a recipient of the first delivered package. Based on the received feedback, one or more computer processors determine the delivery of the first delivered package is successful. In response to determining the delivery of the first delivered package is successful, one or more computer processors extract one or more location identifiers from the first image. Based on the first image, the feedback, and the one or more location identifiers, one or more computer processors generate a location confidence threshold.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a package delivery verification program, on a server computer within the distributed data processing environment of FIG. 1, for validating package delivery to a correct location, in accordance with an embodiment of the present invention; and

FIG. 3 depicts a block diagram of components of the server computer executing the package delivery verification program within the distributed data processing environment of FIG. 1, in accordance with an embodiment of the present invention.

### DETAILED DESCRIPTION

The Courier, Express, and Parcel (CEP) market comprises companies that provide logistics and postal services that vary in the type of services offered, such as delivery speed or weight and volume of a shipment. Delivery services may leave packages on a recipient's doorstep, front porch, or other known area. Often, the delivery courier captures an image of the package in the delivery location to validate delivery of the package. However, the fact that the package is included in the image may not validate that the courier delivered the package to the correct location or address. The area or environment shown in the image may be incorrect, leaving the recipient without an opportunity to stop or modify the delivery. Embodiments of the present invention recognize that efficiency may be gained by iteratively processing delivery location images and generating a location confidence threshold for subsequent delivery images in order to provide successful package deliveries. Implementation of embodiments of the invention may take a variety of forms, and exemplary implementation details are discussed subsequently with reference to the Figures.

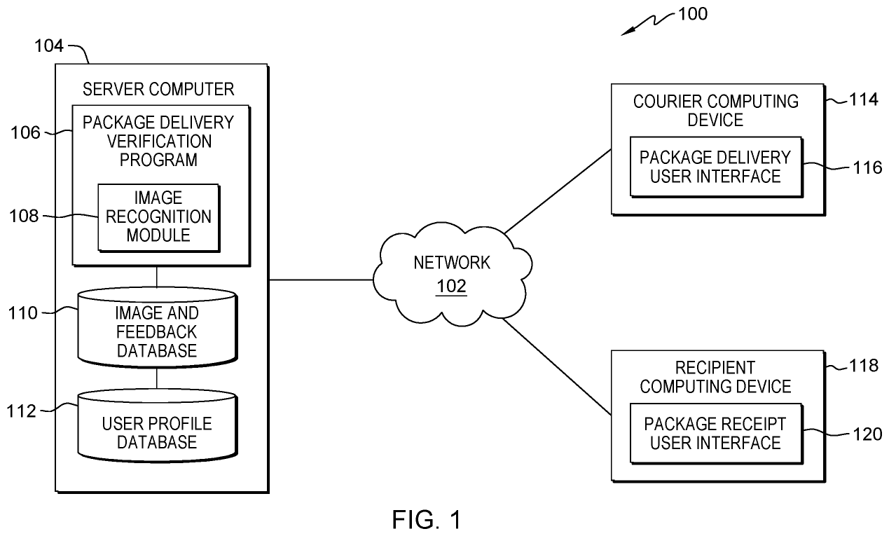

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104, courier computing device 114, and recipient computing device 118, all interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, courier computing device 114, recipient computing device 118, and other computing devices (not shown) within distributed data processing environment 100.

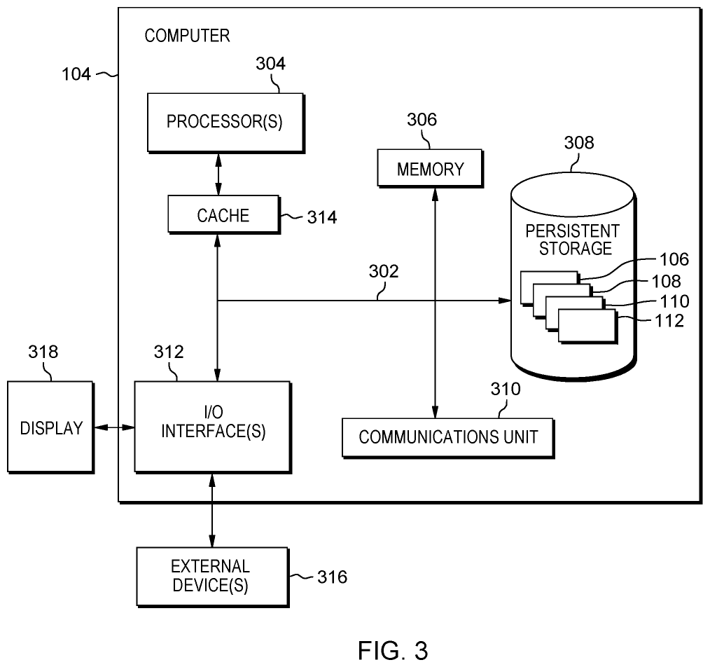

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any programmable electronic device capable of communicating with courier computing device 114, recipient computing device 118, and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes package delivery verification program 106, image recognition module 108, image and feedback database 110, and user profile database 112. Server computer 104 may include internal and external hardware components, as depicted and described in further detail with respect to FIG. 3.

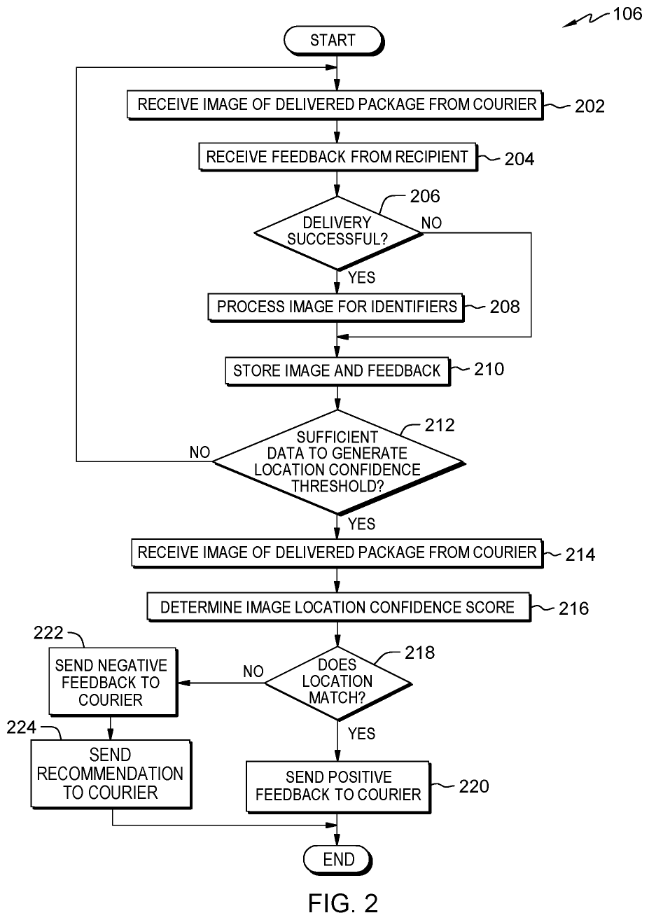

Package delivery verification program 106 correlates images of package delivery locations to verify successful deliveries. Package delivery verification program 106 receives an image of a delivered package from the courier that delivered the package. Package delivery verification program 106 receives feedback from the recipient. Based on the feedback, package delivery verification program 106 determines whether the delivery was successful. If the delivery was successful, then package delivery verification program 106 processes the received image for identifiers. Package delivery verification program 106 stores the image, identifiers (as appropriate), and feedback. Based on the stored image, identifiers, and feedback, package delivery verification program 106 determines whether sufficient data exists to generate a location confidence threshold. If there is not sufficient data, then package delivery verification program 106 continues to receive images of delivered packages at the location until sufficient data exists. Package delivery verification program 106 subsequently receives an image of an additional delivered package. Based on the received image, package delivery verification program 106 determines a location confidence score. Based on the location confidence score, package delivery verification program 106 determines whether the location of the package matches the location indicated by the corresponding location confidence threshold. If the locations match, then package delivery verification program 106 sends positive feedback to the courier. If the location does not match, then package delivery verification program 106 sends negative feedback to the courier and may send a recommendation to the courier to rectify the issue. Package delivery verification program 106 includes image recognition module 108. Package delivery verification program 106 is depicted and described in further detail with respect to FIG. 2.

Image recognition module 108 is one or more of a plurality of software programs in the field of computer vision that can find and identify objects in an image or video sequence. Image recognition module 108 can extract objects in an image and create a list of recognized objects in the image as well as identifying attributes of the recognized objects. For example, image recognition module 108 may analyze an image of door and recognize window as well as the color of the door and the material from which the door was made. In an embodiment, image recognition module 108 may utilize one or more algorithms based on a convolutional neural network. In an embodiment, image recognition module 108 may include optical character recognition (OCR) functionality such that image recognition module 108 can extract the numerals on the door that represent the address. In the depicted embodiment, image recognition module 108 is a separate component of package delivery verification program 106. In another embodiment, the function of image recognition module 108 may be fully integrated into package delivery verification program 106.

Image and feedback database 110 and user profile database 112 are each a repository for data used and generated by package delivery verification program 106. Image and feedback database 110 and user profile database 112 can each represent one or more databases. In the depicted embodiment, image and feedback database 110 and user profile database 112 reside on server computer 104. In another embodiment, image and feedback database 110 and user profile database 112 may each reside elsewhere within distributed data processing environment 100, provided package delivery verification program 106 has access to image and feedback database 110 and user profile database 112. In the depicted embodiment, image and feedback database 110 and user profile database 112 are separate entities. In another embodiment, image and feedback database 110 and user profile database 112 may be included in a combined database. A database is an organized collection of data. Image and feedback database 110 and user profile database 112 can each be implemented with any type of storage device capable of storing data and configuration files that can be accessed and utilized by package delivery verification program 106, such as a database server, a hard disk drive, or a flash memory. Image and feedback database 110 stores images and feedback related to the delivery and receipt of packages. User profile database 112 stores data associated with a package recipient, including, but not limited to, name, address, phone number, email address, customer loyalty status, social network affiliation, images of package delivery locations, image of key identifiers, etc.

The present invention may contain various accessible data sources, such as image and feedback database 110 and user profile database 112, that may include personal data, content, or information the user wishes not to be processed. Personal data includes personally identifying information or sensitive personal information as well as user information, such as tracking or geolocation information. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Package delivery verification program 106 enables the authorized and secure processing of personal data. Package delivery verification program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Package delivery verification program 106 provides information regarding personal data and the nature (e.g., type, scope, purpose, duration, etc.) of the processing. Package delivery verification program 106 provides the user with copies of stored personal data. Package delivery verification program 106 allows the correction or completion of incorrect or incomplete personal data. Package delivery verification program 106 allows the immediate deletion of personal data.

Courier computing device 114 and recipient computing device 118 can each be one or more of a laptop computer, a tablet computer, a smart phone, smart watch, a smart speaker, or any programmable electronic device capable of communicating with various components and devices within distributed data processing environment 100, via network 102. Courier computing device 114 and recipient computing device 118 may each be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In one embodiment, the wearable computer may be in the form of a head mounted display. The head mounted display may take the form-factor of a pair of glasses. In an embodiment, the wearable computer may be in the form of a smart watch or a smart tattoo. In an embodiment, courier computing device 114 and recipient computing device 118 may be integrated into a vehicle of the courier and the recipient, respectively. For example, courier computing device 114 and recipient computing device 118 may each be a heads-up display in the windshield of the vehicle. In general, courier computing device 114 and recipient computing device 118 each represents one or more programmable electronic devices or combination of programmable electronic devices capable of executing machine readable program instructions and communicating with other computing devices (not shown) within distributed data processing environment 100 via a network, such as network 102. Courier computing device 114 includes an instance of package delivery user interface 116. Recipient computing device 118 includes an instance of package receipt user interface 120.

Package delivery user interface 116 provides an interface between package delivery verification program 106 on server computer 104 and a user of courier computing device 114, hereinafter referred to as the courier. Package receipt user interface 120 provides an interface between package delivery verification program 106 on server computer 104 and a user of recipient computing device 118, hereinafter referred to as the recipient. In one embodiment, package delivery user interface 116 and/or package receipt user interface 120 may be mobile application software. Mobile application software, or an “app,” is a computer program designed to run on smart phones, tablet computers and other mobile devices. In one embodiment, package delivery user interface 116 and/or package receipt user interface 120 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. Package delivery user interface 116 enables the courier to input and receive images, feedback, and instructions associated with a package delivery. Package receipt user interface 120 enables the recipient to input user profile data and item delivery information, and to receive and view a notification generated by package delivery verification program 106 or the courier.

FIG. 2 is a flowchart depicting operational steps of package delivery verification program 106, on server computer 104 within distributed data processing environment 100 of FIG. 1, for validating package delivery to a correct location, in accordance with an embodiment of the present invention.

Package delivery verification program 106 receives an image of a delivered package from the courier that delivered the package (step 202). In an embodiment, a courier opts in to the usage of package delivery verification program 106 via package delivery user interface 116, and a recipient opts in to the usage of package delivery verification program 106 via package receipt user interface 120. Upon delivering a package to a location associated with the recipient, the courier captures an image of the package in the location to verify delivery. Package delivery verification program 106 receives the image of the delivered package from the courier via package delivery user interface 116. In an embodiment, the image includes the package and the area surrounding the package in order to depict the location of the package. In an embodiment, the image includes details of a label on the package. For example, the label may include the name and address of the recipient. In another example, the label may include a bar code or a quick response (QR) code which may be scanned to determine details about the package and/or the delivery of the package. In an embodiment, package delivery verification program 106 may receive an image of the package from the recipient. For example, upon receipt of the package, the recipient may capture and upload a photograph of the package in the location where it was delivered to package receipt user interface 120. In another example, the recipient may connect to a social photo sharing service to retrieve a photo of the delivery location, and, using global positioning service (GPS) coordinates included in the metadata associated with the photo, package delivery verification program 106 can determine the location of the package delivery. In an embodiment, the delivery location may be a vehicle.

Package delivery verification program 106 receives feedback from the recipient regarding the delivered package (step 204). In an embodiment, package delivery verification program 106 receives feedback from the recipient via package receipt user interface 120. For example, package delivery verification program 106 may transmit a message to the recipient, via package receipt user interface 120, and the recipient may respond to the message with an indication of whether the delivery was successful. In another example, the recipient may provide feedback associated with a delivery unprompted, via package receipt user interface 120. In a further example, the recipient may request a return of the delivered package. In yet another example, the recipient may report an issue with the delivery, such as a missing part. In another embodiment, package delivery verification program 106 may receive feedback from the recipient by inferring the feedback if none is received. For example, if a user is satisfied with the delivery, the user may not take the time to provide package delivery verification program 106 with feedback, and package delivery verification program 106 determines that a lack of feedback indicates a successful delivery.

Package delivery verification program 106 determines whether the delivery was successful (decision block 206). Based on the received feedback, package delivery verification program 106 determines whether the package delivery was successful.

If the delivery was successful (“yes” branch, decision block 206), then package delivery verification program 106 processes the received image for identifiers (step 208). In an embodiment, package delivery verification program 106 uses image recognition module 108 to process the received image for identifiers of the location. In an embodiment, the identifiers may be classified into unique domains, such as a list of objects, images of objects, and corresponding attributes. Image recognition module 108 extracts images of objects and corresponding attributes from the received image as well as creating a list of the extracted objects. For example, image recognition module 108 may identify and extract unique objects at the front door of the home of the recipient, where the courier delivered the package, such as a potted plant, a welcome mat, text on the welcome mat, a statue, a wreath, a window, the door, and a door knob. Image recognition module 108 may also extract attributes associated with the objects. For example, image recognition module 108 may identify materials in the location, such as brick, wood, or aluminum siding. In another example, image recognition module 108 may identify attributes of the materials, such as a shade of brick, a type of wood, a color of a door, etc. In an embodiment, image recognition module 108 may differentiate between static and non-static entities in a captured image. For example, image recognition module 108 may determine that a welcome mat or a plant may be non-static entities that may change over time, while a brick wall or a door are static and less flexible. In an embodiment, a recipient may identify a key artifact, via package receipt user interface 120, for image recognition module 108 to use as an identifier in order to validate that a delivery location is correct. For example, a recipient may upload an image that includes a welcome mat, a building column, a mailbox, etc., that must be included in an image with a delivered package to validate a successful delivery. In the embodiment, the recipient can alert package delivery verification program 106 of a change to a key artifact in order to preemptively overcome any negative feedback on the delivery location due to the key artifact being replaced. For example, a recipient may upload a new image, via package receipt user interface 120, which indicates a change to a seasonal rug or wreath that the recipient previously identified as a key artifact. In an embodiment, image recognition module 108 may use OCR functionality to recognize a house or apartment number on a wall, door, or mailbox.

Responsive to processing the image for identifiers or if package delivery verification program 106 determines the delivery was unsuccessful (“no” branch, decision block 206), then package delivery verification program 106 stores the image and feedback (step 210). In an embodiment, package delivery verification program 106 stores the image and associated feedback with the delivery location in image and feedback database 110. In an embodiment where the delivery was successful and image recognition module 108 extracted identifiers associated with the image, package delivery verification program 106 stores the identifiers with the associated image and feedback. In an embodiment where a delivery location is associated with more than one recipient, package delivery verification program 106 stores the image and feedback of the related recipients as a cluster. For example, if multiple family members live at the same address, then package delivery verification program 106 stores images and feedback associated with deliveries requested by the various family members as a recipient cluster in image and feedback database 110. In another example, if recipients are residents in an apartment building, whose addresses only differ by apartment number, then package delivery verification program 106 stores images and feedback associated with deliveries to the apartment building as a recipient cluster in image and feedback database 110.

Package delivery verification program 106 determines whether sufficient data exists to generate a location confidence threshold (decision block 212). Package delivery verification program 106 uses a confidence score to determine whether an actual delivery location matches an intended delivery location. Based on the stored images, feedback, and any extracted identifiers, package delivery verification program 106 determines whether enough packages have been successfully, or unsuccessfully, delivered to the location to generate a location confidence threshold. In an embodiment, a system administrator pre-defines the quantity of data needed to perform a statistical analysis which can generate a location confidence threshold. For example, a location confidence threshold may be a 75 percent success rate on deliveries at the location. In another embodiment, the location confidence threshold may be based on a number of objects extracted from the image and the number of times the same objects are extracted. In an embodiment, package delivery verification program 106 may dynamically update the location confidence threshold as additional data is received. For example, if package delivery verification program 106 receives a pre-defined number of negative feedback instances, then package delivery verification program 106 can raise the location confidence threshold that has to be met in order to improve delivery outcomes. In an embodiment, package delivery verification program 106 utilizes machine learning algorithms to continually self-improve the location confidence as package delivery verification program 106 receives new images and processes details of the images. Over time, package delivery verification program 106 verifies attributes of the received images which strengthens the attributes as indicators of a correct delivery location.

If there is not sufficient data to generate a location confidence threshold (“no” branch, decision block 212), then package delivery verification program 106 returns to step 202 and continues to receive images of delivered packages at the location until sufficient data exists. Package delivery verification program 106 iterates through steps 202 through 212 until enough data is available to generate a confidence in an image that the picture taken is in the same location as the other images of packages delivered to that location.

After package delivery verification program 106 generates a location confidence threshold (“yes” branch, decision block 212), package delivery verification program 106 receives an image of a subsequently delivered package from the courier (step 214). Subsequent to enough deliveries having been made to a location for package delivery verification program 106 to generate a location confidence threshold, package delivery verification program 106 receives an image from the courier of an additional package delivered to the location, as discussed with respect to step 202.

Package delivery verification program 106 determines a location confidence score (step 216). Package delivery verification program 106 compares the newly received image, and associated data, to the images and data stored in image and feedback database 110 to determine a location confidence score of the latest delivery, i.e., whether the delivery is in the correct location. For example, in previous deliveries, package delivery verification program 106, or image recognition module 108, extracted a house number, a welcome mat, and a wreath from two images of a location, but package delivery verification program 106 extracted only the house number and welcome mat from an additional ten images of the location. Because the wreath is likely a seasonal item, the location confidence score can be relatively high even though there is not an exact match. In an example where the delivery location is a vehicle, package delivery verification program 106 can determine if the vehicle is parked within a normal orientation or location for a delivery.

Package delivery verification program 106 determines whether the location matches (decision block 218). In an embodiment, package delivery verification program 106 compares the location confidence score to the location confidence threshold to determine whether the current delivery location matches the previous delivery location. If the location confidence score of the current delivery location exceeds the location confidence threshold, then package delivery verification program 106 determines the current location matches the previous location. In an embodiment, package delivery verification program 106 determines whether a match exists by comparing the unique domains, such as a list of objects, images of objects, and corresponding attributes, of the current image to the previous image.

If the location matches (“yes” branch, decision block 218), then package delivery verification program 106 sends positive feedback to the courier (step 220). If package delivery verification program 106 determines that the current delivery location is the same as the previous delivery location, then package delivery verification program 106 transmits positive feedback and confirmation to the courier via package delivery user interface 116. The positive feedback indicates that the courier delivered the package to the correct location. In an embodiment, package delivery verification program 106 receives positive feedback from the recipient, via package receipt user interface 120, and sends the positive feedback to the courier, via package delivery user interface 116.

If the location does not match (“no” branch, decision block 218), then package delivery verification program 106 sends negative feedback to the courier (step 222). If package delivery verification program 106 determines that the current delivery location is not the same as the previous delivery location, then package delivery verification program 106 transmits negative feedback to the courier via package delivery user interface 116. The negative feedback indicates that the courier delivered the package to the wrong location. In an embodiment, the negative feedback may include evidence of the difference in the images. In an embodiment, package delivery verification program 106 receives negative feedback from the recipient, via package receipt user interface 120, and sends the negative feedback to the courier, via package delivery user interface 116.

Package delivery verification program 106 sends a recommendation to the courier (step 224). In an embodiment, in an effort to rectify a delivery issue, package delivery verification program 106 transmits a recommendation of how to remedy the incorrect delivery, via package delivery user interface 116. For example, if package delivery verification program 106 determines the package is in the wrong location, then package delivery verification program 106 may instruct the courier to scan a bar code on the label to verify the address. In an embodiment, package delivery verification program 106 may request manual validation and verification from the courier prior to overriding the negative location match and leaving the package. In an embodiment, package delivery verification program 106 may send a recommendation or additional instructions to the courier prior to the delivery of a package. For example, package delivery verification program 106 may compare neighbor identifiers and alert the courier that two neighboring apartments have similar front doors, therefore the courier should validate the address. In another example, package delivery verification program 106 may extract metadata from a received image, such as azimuth of the location, and send the information to the courier to confirm proper delivery or assist in validating the location.

The following is an example scenario which describes the operation of package delivery verification program 106. In the example, a courier delivers a package to a location where several deliveries have been made in the past and captures an image of the package in the delivery location. The image included the house number on the door, which was 7455, however the correct house number was 7545. Upon receipt of the image, package delivery verification program 106 determines a location confidence score for the delivery location based on the image, as described with respect to step 216 of FIG. 2. The location confidence score did not meet the location confidence threshold, therefore package delivery verification program 106 determines the location does not match, as described with respect to decision block 218 of FIG. 2. Package delivery verification program 106 sends negative feedback to the courier, via package delivery user interface 116, that indicates that the courier delivered the package to the wrong location, as described with respect to step 222 of FIG. 2. Package delivery verification program 106 sends a recommendation to the courier to remove the package from the current location and take the package down the street to the correct address, as described with respect to step 224 of FIG. 2. Later, the courier delivers the package to the location with the house number 7545 and captures an image of the package that includes the house number. Upon receipt of the image, package delivery verification program 106 determines a location confidence score for the delivery location based on the image, as described with respect to step 216 of FIG. 2. The location confidence score meets the location confidence threshold, therefore package delivery verification program 106 determines the location matches, as there is a 1:1 match between the delivery location and one or more images stored in image and feedback database 110 from previous deliveries to that location, as described with respect to decision block 218 of FIG. 2. Package delivery verification program 106 sends positive feedback to the courier, via package delivery user interface 116, that indicates that the courier delivered the package to the correct location, as described with respect to step 220 of FIG. 2.

FIG. 3 depicts a block diagram of components of server computer 104 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computer 104 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., package delivery verification program 106, image recognition module 108, image and feedback database 110, and user profile database 112, are stored in persistent storage 308 for execution and/or access by one or more of the respective processor(s) 304 of server computer 104 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of courier computing device 114 and recipient computing device 118. In these examples, communications unit 310 includes one or more network interface cards. Communications unit 310 may provide communications through the use of either or both physical and wireless communications links. Package delivery verification program 106, image recognition module 108, image and feedback database 110, user profile database 112, and other programs and data used for implementation of the present invention, may be downloaded to persistent storage 308 of server computer 104 through communications unit 310.

I/O interface(s) 312 allows for input and output of data with other devices that may be connected to server computer 104. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., package delivery verification program 106, image recognition module 108, image and feedback database 110, and user profile database 112 on server computer 104, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method, the method comprising:
receiving, by one or more computer processors, a first image of a first delivered package from a courier, wherein the image includes an indication of a first delivery location of the first delivered package;
receiving, by one or more computer processors, feedback associated with receipt of the first delivered package from a recipient of the first delivered package;
based on the received feedback, determining, by one or more computer processors, the delivery of the first delivered package is successful;
responsive to determining the delivery of the first delivered package is successful, extracting, by one or more computer processors, one or more location identifiers from the first image; and
based on the first image, the feedback, and the one or more location identifiers, generating, by one or more computer processors, a location confidence threshold.

2. The method of claim 1, further comprising:
receiving, by one or more computer processors, a second image of a second delivered package, wherein the second image includes an indication of a second delivery location of the second delivered package;
based on the second image, determining, by one or more computer processors, a location confidence score of the second delivery location;
determining, by one or more computer processors, the location confidence score exceeds the location confidence threshold;
responsive to determining the location confidence score exceeds the location confidence threshold, determining, by one or more computer processors, the second delivery location matches the first delivery location; and
sending, by one or more computer processors, positive delivery feedback to the courier.

3. The method of claim 1, further comprising:
receiving, by one or more computer processors, a third image of a third delivered package, wherein the third image includes an indication of a third delivery location of the third delivered package;
based on the third image, determining, by one or more computer processors, a location confidence score of the third delivery location;
based on the location confidence score, determining, by one or more computer processors, the third delivery location does not match the first delivery location;
sending, by one or more computer processors, negative delivery feedback to the courier; and
sending, by one or more computer processors, a recommendation to the courier.

4. The method of claim 1, wherein generating the location confidence threshold comprises determining, by one or more computer processors, a percentage of a success rate of deliveries at the first delivery location.

5. The method of claim 1, wherein generating the one or more location identifiers from the first image further comprises:
extracting, by one or more computer processors, one or more objects from the first image; and
classifying, by one or more computer processors, the one or more objects into unique domains, wherein the unique domains are selected from the group consisting of a list of objects, an image of an object, and an attribute of an object.

6. The method of claim 5, wherein generating the location confidence threshold comprises determining, by one or more computer processors, a number of times the one or more objects are extracted from the first image and from one or more additional images.

7. The method of claim 1, further comprising, storing, by one or more computer processors, the first image, the feedback, and the identifiers in association with the first delivery location.

8. A computer program product, the computer program product comprising:
one or more computer readable storage media and program instructions collectively stored on the one or more computer readable storage media, the stored program instructions comprising:
program instructions to receive a first image of a first delivered package from a courier, wherein the image includes an indication of a first delivery location of the first delivered package;
program instructions to receive feedback associated with receipt of the first delivered package from a recipient of the first delivered package;
based on the received feedback, program instructions to determine the delivery of the first delivered package is successful;
responsive to determining the delivery of the first delivered package is successful, program instructions to extract one or more location identifiers from the first image; and
based on the first image, the feedback, and the one or more location identifiers, program instructions to generate a location confidence threshold.

9. The computer program product of claim 8, the stored program instructions further comprising:
program instructions to receive a second image of a second delivered package, wherein the second image includes an indication of a second delivery location of the second delivered package;
based on the second image, program instructions to determine a location confidence score of the second delivery location;
program instructions to determine the location confidence score exceeds the location confidence threshold;
responsive to determining the location confidence score exceeds the location confidence threshold, program instructions to determine the second delivery location matches the first delivery location; and
program instructions to send positive delivery feedback to the courier.

10. The computer program product of claim 8, the stored program instructions further comprising:
program instructions to receive a third image of a third delivered package, wherein the third image includes an indication of a third delivery location of the third delivered package;
based on the third image, program instructions to determine a location confidence score of the third delivery location;
based on the location confidence score, program instructions to determine the third delivery location does not match the first delivery location;
program instructions to send negative delivery feedback to the courier; and
program instructions to send a recommendation to the courier.

11. The computer program product of claim 8, wherein the program instructions to generate the location confidence threshold comprise program instructions to determine a percentage of a success rate of deliveries at the first delivery location.

12. The computer program product of claim 8, wherein the program instructions to generate the one or more location identifiers from the first image comprise:
program instructions to extract one or more objects from the first image; and
program instructions to classify the one or more objects into unique domains, wherein the unique domains are selected from the group consisting of a list of objects, an image of an object, and an attribute of an object.

13. The computer program product of claim 12, wherein the program instructions to generate the location confidence threshold comprise program instructions to determine a number of times the one or more objects are extracted from the first image and from one or more additional images.

14. The computer program product of claim 8, the stored program instructions further comprising program instructions to store the first image, the feedback, and the identifiers in association with the first delivery location.

15. A computer system, the computer system comprising:
one or more computer processors;
one or more computer readable storage media;
program instructions collectively stored on the one or more computer readable storage media for execution by at least one of the one or more computer processors, the stored program instructions comprising:
program instructions to receive a first image of a first delivered package from a courier, wherein the image includes an indication of a first delivery location of the first delivered package;
program instructions to receive feedback associated with receipt of the first delivered package from a recipient of the first delivered package;
based on the received feedback, program instructions to determine the delivery of the first delivered package is successful;
responsive to determining the delivery of the first delivered package is successful, program instructions to extract one or more location identifiers from the first image; and
based on the first image, the feedback, and the one or more location identifiers, program instructions to generate a location confidence threshold.

16. The computer system of claim 15, the stored program instructions further comprising:
program instructions to receive a second image of a second delivered package, wherein the second image includes an indication of a second delivery location of the second delivered package;
based on the second image, program instructions to determine a location confidence score of the second delivery location;
program instructions to determine the location confidence score exceeds the location confidence threshold;
responsive to determining the location confidence score exceeds the location confidence threshold, program instructions to determine the second delivery location matches the first delivery location; and
program instructions to send positive delivery feedback to the courier.

17. The computer system of claim 15, the stored program instructions further comprising:
program instructions to receive a third image of a third delivered package, wherein the third image includes an indication of a third delivery location of the third delivered package;
based on the third image, program instructions to determine a location confidence score of the third delivery location;
based on the location confidence score, program instructions to determine the third delivery location does not match the first delivery location;
program instructions to send negative delivery feedback to the courier; and
program instructions to send a recommendation to the courier.

18. The computer system of claim 15, wherein the program instructions to generate the location confidence threshold comprise program instructions to determine a percentage of a success rate of deliveries at the first delivery location.

19. The computer system of claim 15, wherein the program instructions to generate the one or more location identifiers from the first image comprise:
program instructions to extract one or more objects from the first image; and
program instructions to classify the one or more objects into unique domains, wherein the unique domains are selected from the group consisting of a list of objects, an image of an object, and an attribute of an object.

20. The computer system of claim 19, wherein the program instructions to generate the location confidence threshold comprise program instructions to determine a number of times the one or more objects are extracted from the first image and from one or more additional images.
